(19) United States
(12) Patent Application Publication
(10) Pub. No.: US 2025/0080212 A1
(43) Pub. Date: Mar. 6, 2025

(54) FOLDABLE USER COMMUNICATION DEVICE WITH LOW PROFILE PATCH ANTENNA FOR SATELLITE COMMUNICATIONS

(71) Applicant: MOTOROLA MOBILITY LLC, WILMINGTON, DE (US)

(72) Inventors: JUNSHENG ZHAO, VERNON HILLS, IL (US); XUYUAN PAN, CHICAGO, IL (US); MD FAISAL ABEDIN, LAKE BLUFF, IL (US); MOHAMMED ABDUL-GAFFOOR, PALATINE, IL (US)

(21) Appl. No.: 18/456,607

(22) Filed: Aug. 28, 2023

(51) Int. Cl. H04B 7/185; H01Q 1/24; H01Q 9/04; H04M 1/02; H04W 4/90

(52) U.S. Cl. CPC H04B 7/18517; H01Q 1/243; H01Q 9/0407; H04M 1/0206; H04W 4/90

(57) ABSTRACT

A communication device, method and computer program product enable satellite communication via a patch antenna incorporated into foldable device having two housings that form a housing assembly coupled at a hinge to pivot between folded and unfolded positions. The patch antenna is positioned at a back portion of the housing assembly and includes a ground plane, a substrate of low dielectric constant and low loss material positioned on the ground plane, and a conductive radiator patch positioned on the substrate. In response to identifying a trigger to execute a communications application, a controller of the communication device communicates, via a communications subsystem and the patch antenna, with a communications satellite. In one or more embodiments, a display is positioned on, but spaced inward from an outer edge of, the patch antenna to display information even while the housing assembly is in the folded position.

### BACKGROUND

### 1. Technical Field

The present disclosure relates generally to foldable portable communication devices, and more particularly to foldable portable communication devices that support satellite communication.

### 2. Description of the Related Art

Portable electronic communication devices, particularly smartphones, have become ubiquitous. People all over the world use such devices to stay connected. These devices have been designed in various mechanical configurations. One such configuration is a “clamshell” configuration, which is a foldable device that has a mechanical hinge, which allows one housing to pivot relative to the other in a folded position, enabling the device to become smaller for easier stowing and carry. Certain user interfacing features and other device functions may be available while the device is in the folded position, such as via a display on a backside of one of the housings. Additional features and functions may be available in the unfolded position, such as via one or more displays located on inward sides of the housings.

Antennas are incorporated into the foldable communication devices to support communications in one or more radio frequency (RF) bands using one or more communication protocols. Locations on the foldable communication devices for antennas are limited by the overall small size of the portable communication devices and by one or more displays that can cover a front side and portions of a back side. Certain components brought together when the device is in the folded position can also degrade antenna performance. Some RF bands may be supportable by antennas positioned along thin lateral edges of the communication devices. However, some antennas need to be on the front side or the back side due to their size. In an example, patch antennas for satellite communication have a large footprint. Conventional antennas for satellite communication utilize a thick ceramic substrate that is not feasible or desirable for incorporating into a foldable communication device with a small form factor and both interior and exterior positioned displays occupying the majority of the external device surface.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a simplified functional block diagram and back unfolded view of a communication device having a low-profile satellite patch antenna, according to one or more embodiments;

FIG. 1B is a front view of the communication device of FIG. 1A while in the unfolded position, according to one or more embodiments;

FIG. 1C is a first back view of the patch antenna integrated at a surface of a first housing of the communication device of FIG. 1A that is in a folded position, according to one or more embodiments;

FIG. 1D is a second back view of a second housing of the communication device of FIG. 1A in a folded position, according to one or more embodiments;

FIG. 2 is a front view of the patch antenna of FIG. 1A that supports a functional component such as a display, electromagnetic coil, or radio frequency (RF) antenna, according to one or more embodiments;

FIG. 3 is a side view of the patch antenna of FIG. 1A supporting the functional component, according to one or more embodiments;

FIG. 4 is a three-dimensional view of the patch antenna of FIG. 1A supporting the functional component and annotated with electromagnetic flux lines of a fringe field, according to one or more embodiments;

FIG. 5 is a side cutaway view of the patch antenna of FIG. 4 supporting the functional component and annotated with electromagnetic flux lines including a probe line that transfers signals to the patch antenna, according to one or more embodiments;

FIG. 6 is a graphical plot of realized peak gain in decibels (dB) as a function of frequency of the patch antenna of FIGS. 1A, 1C, and 2-5, according to one or more embodiments;

FIG. 7A is a back view of a second example communication device having a clamshell foldable design form that is unfolded with the patch antenna on a flip housing and no additional displays on back sides of the housing assembly, according to one or more embodiments;

FIG. 7B is a three-dimensional front view of the second example communication device of FIG. 7A being held in the unfolded position with a main display being viewable but tipped forward to orient the patch antenna upward for satellite coverage, according to one or more embodiments;

FIG. 8A is a back view of a third example communication device having a clamshell foldable design form that is unfolded with an additional display positioned on the patch antenna on the back side of the flip housing, according to one or more embodiments;

FIG. 8B is a three-dimensional front view of the third example communication device of FIG. 8A in a first use scenario being held in the unfolded position with a main display being viewable but tipped forward to orient the patch antenna upward for satellite coverage, according to one or more embodiments;

FIG. 8C is a three-dimensional back view of the third example communication device of FIG. 8A in a second use scenario being held in the unfolded position with the additional display being viewable on the flip housing but tipped away from the user to orient the patch antenna upward for satellite coverage, according to one or more embodiments;

FIG. 8D is a three-dimensional back view of the third example communication device of FIG. 8A in a third use scenario being held in the folded position with the additional display being viewable upside down on the flip housing but tipped away from the user to orient the patch antenna upward for satellite coverage, according to one or more embodiments;

FIG. 8E is a three-dimensional back view of the third example communication device of FIG. 8A in a fourth use scenario of the base housing being held vertically with a corresponding portion of the main display being viewable while the flip housing is horizontal in the tripod position of about 90° pivot position orienting the patch antenna upward for satellite coverage, according to one or more embodiments;

FIG. 9A is a back view of a fourth example communication device having a clamshell foldable design form that is unfolded with an additional display positioned on the back side of the flip housing and the patch antenna positioned on the back side of the base housing, according to one or more embodiments;

FIG. 9B is a three-dimensional front view of the fourth example communication device of FIG. 9A in a first use scenario held upside down in the unfolded position with the main display being viewable but tipped forward to orient the patch antenna upward for satellite coverage, according to one or more embodiments;

FIG. 9C is a three-dimensional back view of the fourth example communication device of FIG. 9A in a second use scenario held upside down in the unfolded position with the additional display being viewable but tipped away from the user to orient the patch antenna upward for satellite coverage, according to one or more embodiments;

FIG. 9D is a three-dimensional view of the fourth example communication device of FIG. 9A in a third use scenario positioned with hinge up in a partially unfolded book stand/tent position of less than 90° pivot position with the additional display being viewable on one side and the patch antenna oriented generally upward for satellite coverage on an opposite side, according to one or more embodiments;

FIG. 9E is a three-dimensional back view of the fourth example communication device of FIG. 9A in a fourth use scenario with the flip housing being held vertically with a corresponding upside down portion of the main display being viewable while the base housing is horizontal in the tripod position of about 90° pivot position orienting the patch antenna upward for satellite coverage, according to one or more embodiments;

FIG. 10A is a back view of a fifth example communication device having a book-fold design form that is folded with no additional display and the patch antenna positioned on a first housing of a housing assembly, according to one or more embodiments;

FIG. 10B is a front view of the fifth example communication device of FIG. 10A in an unfolded position to expose a main display across front sides of the first housing and a second housing of the housing assembly, according to one or more embodiments;

FIG. 10C is a three-dimensional back view of the fifth example communication device of FIG. 10A in a use scenario with the second housing being held vertically and rotated a quarter leftward downward with a corresponding portion of the main display being viewable while the first housing is horizontal in the tripod position of about 90° pivot position orienting the patch antenna upward for satellite coverage, according to one or more embodiments;

FIG. 11A is a back view of a sixth example communication device having a book-fold design form that is unfolded with an additional display on the back side of the first housing beside the patch antenna, according to one or more embodiments;

FIG. 11B is a three-dimensional back view of the sixth example communication device of FIG. 11A in a use scenario being held in the folded position with the additional display being viewable on the first housing but tipped away from the user to orient the patch antenna upward for satellite coverage, according to one or more embodiments; and

FIG. 12 is a flow diagram presenting a method of communicating with a satellite via a patch antenna and displaying a status of the communication at a communication device that has a foldable design form, according to one or more embodiments.

### DETAILED DESCRIPTION

According to aspects of the present disclosure, a communication device, a method, and a computer program product provide satellite communication via a patch antenna attached to a display incorporated into a housing of a foldable user device. A housing assembly of the communication device includes first and second housings coupled at a hinge to pivot between a fully folded position and a fully unfolded position. The patch antenna is attached to a display that is positioned at a back portion of the housing assembly that is exposed in both the fully folded position and the fully unfolded position. The patch antenna includes: (i) a ground plane; (ii) a substrate comprising a low dielectric constant and low loss material and positioned on the ground plane; and (iii) a conductive radiator patch positioned on the substrate. In one or more embodiments, the communication device further includes a communications subsystem configured to allow the communication device to communicate with a communications satellite via at least one of an uplink and a downlink completed with the patch antenna. The communication device includes a memory that stores a satellite communications application. A controller of the communication device is communicatively coupled to the communications subsystem and the memory. In response to identifying a trigger to execute the satellite communications application, the controller, via the communications subsystem and the patch antenna, communicates with the communications satellite. In one or more embodiments, while patch antenna is oriented upward to communicate with the satellite, at least one display of the communication device is viewable by user to confirm status of the satellite communication.

The present disclosure addresses particular challenges for satellite communications by a portable hand-held device. Unlike with global positioning system (GPS) communication, which requires only a GPS receiver to receive GPS satellite signals, satellite communications includes transmitting as well as receiving signals. Because the satellite signal is right hand circular polarized (RHCP), a typical linear polarized antenna for wireless communications is not preferred for satellite communications. The present disclosure provides for an RHCP patch antenna in addition to the linear polarized antenna for wireless communications within the same form factor of the communication device. A RHCP patch antenna inherently has a 3 dB higher antenna gain as compared to a linear antenna for transceiving an RHCP signal (i.e., the linear antenna loses half of the antenna performance of the RHCP patch antenna). The RHCP patch antenna has a wide main beam which reduces the reliance of aligning the antenna pattern with the position/location of the satellites, which may result in an enhanced user experience by acquiring a radio link quicker. In addition, among RHCP antennas, a patch antenna solution is more desired due to several inherent advantages including higher performance, low profile, low cost, and simplified fabrication, etc. Particular embodiments of the RHCP patch antenna according to the present disclosure have a particularly low profile of 0.5-1.0 mm thickness by using a low dielectric constant plastic substrate with low loss. By contrast, conventional satellite antennas have a 4 mm thick ceramic substrate along with a relatively large ground plane, which may be unsuitable or at least undesirable for use in a portable device.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

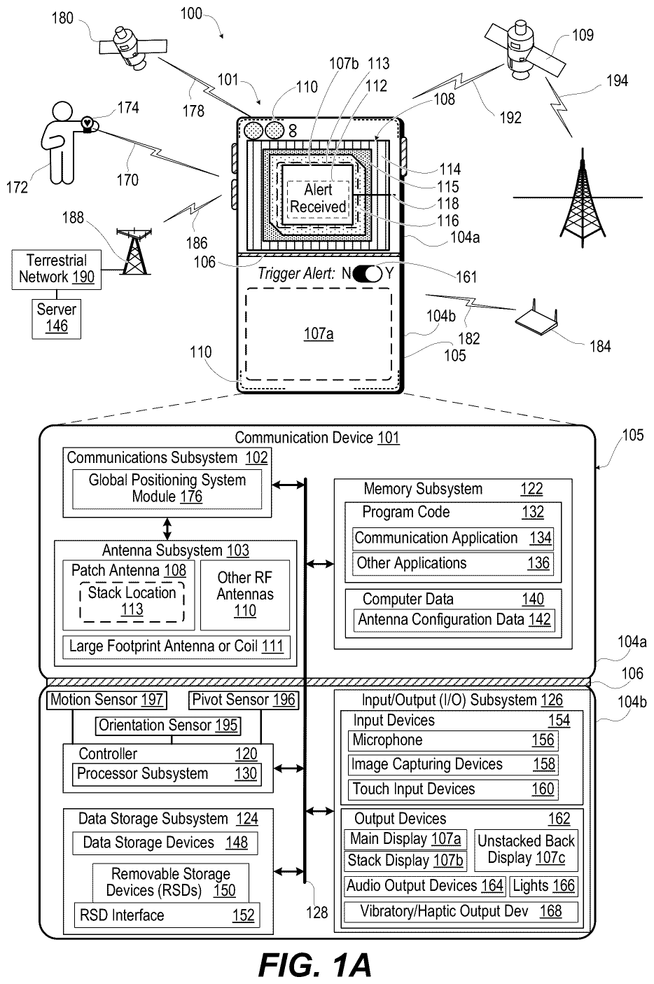

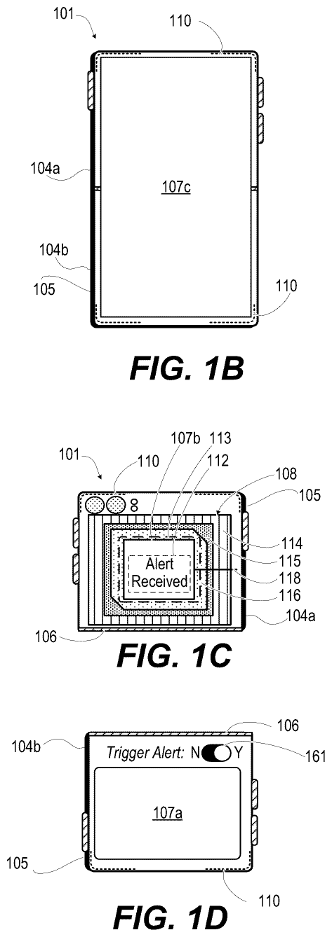

FIG. 1A presents a simplified functional block diagram of a communication device 101 having a foldable design form factor that may operate as a mobile user device in communication environment 100, in which the features of the present disclosure are advantageously implemented. Communication device 101 can be one of a host of different types of devices, including but not limited to, a mobile cellular phone, satellite phone, or smart phone, a laptop, a netbook, an ultra-book, a networked smartwatch or networked sports/exercise watch, and/or a tablet computing device or similar device that can include wireless communication functionality. As a device supporting wireless communication, communication device 101 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices.

Communication device 101 includes communications subsystem 102 that performs radio frequency (RF) communication via antenna subsystem 103 incorporated into first and second housings 104a-104b of housing assembly 105. First and second housings 104a-104b are coupled at hinge 106 to pivot between a fully folded position and a fully unfolded position. In one or more embodiments, communication device 101 of FIGS. 1A-10D has a “clamshell” foldable design form with first housing 104a being referred to as a “flip housing” and second housing 104b being referred to as a “base housing”. When held and viewed, a clamshell foldable design form is intended to have hinge 106 horizontal. When folded, hinge 106 is on top with flip housing 104b being toward a user who holds base housing 104b oriented away. The user's thumb of the gripping hand or the user's free hand may flip up flip housing 104a to the unfolded position to expose main display 107a across front sides of first and second housings 104a-104b (FIG. 1B).

Locations available for incorporating antenna subsystem 103 are limited, especially when housing assembly 105 is folded and the exterior surfaces are reduced by almost half. One or more displays (collectively “displays 107”) require planar areas on front or back faces of first and second housings 104a-104b, further limiting the locations available for antenna subsystem 103. Communications subsystem 102 is communicatively connectable, via patch antenna 108 of antenna subsystem 103, to satellites 109 for communication services. Patch antenna 108 has a large “footprint” requiring a planar surface and requiring exposed, upward orientation toward satellites 109 to communicate. Front sides of first and second housings 104a-104b do not provide a suitable location for patch antenna 108 as blocking communication in the folded position and by being used for main display 107a. Thus, the present disclosure provides examples of placement of patch antenna 108 on a backside of one of first and second housings 104a-104b. In addition, the present disclosure provides examples of alternate embodiments with additional display (e.g., display 107b that is smaller than patch antenna 108 and unstacked back display 107c) that may be available on one or both back sides of first and second housings 104a-104b. One or more displays become available for viewing at pivot positions of housing assembly 105 from folded, tent or book-stand position (i.e., <90°), tripod position (about 90°), and fully unfolded position while orienting patch antenna 108 upward. Examples of these configures are described below for the following additional embodiments: Communication device 101a (7A-7B) is a clamshell device having only one display (main display 107a). Patch antenna 108 is positioned on first housing 104a. Communication device 101b (8A-8E) is a clamshell design form but also includes display 107b positioned on patch antenna 108 on first housing 104a. Communication device 101c (9A-9E) is also a clamshell foldable design forms but having unstacked back display 107c positioned on first housing 104a and patch antenna 108 positioned on second housing 104b. Communication device 101d (10A-10C) is a “book-fold” design form with only one display (main display 107a) and with patch antenna 108 on the back side of first housing 104a. In a book-fold design form, hinge 106a is intended to be oriented vertically. When viewing main display 107a, first housing 104a is located toward the left and second housing is toward the right. Communication device 101e (11A-11B) has a book-fold design form having patch antenna 108 and unstacked back display 107c on a back side of first housing 104a.

With continued reference to FIG. 1A, in addition to patch antenna 108, antenna subsystem 103 may include RF antennas 110 that have a small footprint that do not require positioning on a large planar surface of housing assembly 105. RF antennas 110 may be incorporated at, or proximate to, thin edges along right, left, top, and bottom edges of first and second housings 104a-104b.

In one or more embodiments, patch antenna 108 has stack location 113 that is not utilized by one or more functional components. In one or more embodiments, patch antenna 108 may be stacked with one or more functional components to more efficiently utilize exterior areas/locations on housing assembly 105 without significantly degrading antenna efficiency. In an example, display 107b may be positioned over patch antenna 108, enabling presentation of display content 112 related to satellite communications while housing assembly 105 is folded or unfolded. In addition to satellite communication capabilities, communication device 101 may include other wireless and cellular RF communication or energy transfer capabilities supported by one or more second antenna or coil 111 that also have a large footprint. As an alternative to or in addition to display 107b, second antenna or coil 111 may be stacked with patch antenna 108 at stack location 113 to better utilize available exterior facing antenna locations on housing assembly 105. Examples of second antenna or coil 111 that are planar with a large footprint include a near field communication (NFC) antenna, an ultra-wideband (UWB) antenna, and a wireless charger (WLC) coil. A WLC coil inductively couples to an electromagnetic field generated by a wireless charger over a short distance rather than producing or receiving an RF broadcast signal.

FIG. 1B is a front view of the communication device 101 of FIG. 1A while in the unfolded position. Flexible display 107c extends across inward faces of first and second housings 104a-104b. In one or more embodiments, flexible display 107c precludes placement of large footprint antennas on the inward faces of first and second housings 104a-104b. In addition, antennas on the inward faces of first and second housings 104a-104b would be blocked while housing assembly 105 is in the folded position. RF antennas 110 may be positioned on inward faces of first and second housings 104a-104b for spatial diversity for certain communication bands while housing assembly 105 is at least partially unfolded. FIG. 1C is a first back view of first housing 104a of communication device 101 of FIG. 1A while in a folded position. FIG. 1D is a second back view of second housing 104b of communication device 101 of FIG. 1A while in a folded position. With reference to FIGS. 1A-1D, communication device 101 is a “clamshell” foldable device, intended to be held such that hinge 106 is horizontal with flipping occurring vertically.

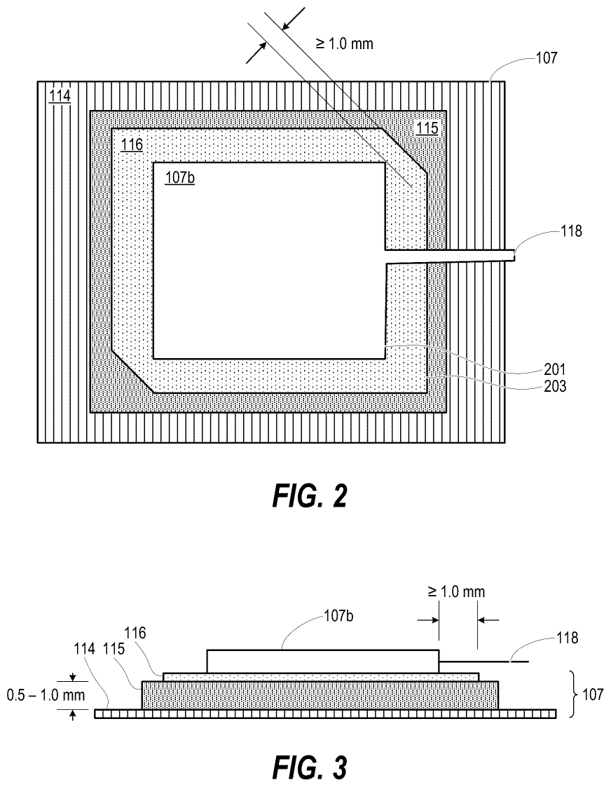

FIG. 2 is a front view of display 107b positioned on an exposed surface of patch antenna 108 as an example of stacking a functional component without significantly degrading antenna efficiency of patch antenna 108. An opposite surface of patch antenna 108 is inwardly directed toward communication device 101 (FIGS. 1A-1D) and is affixed, attached, or incorporated in an outer surface of housing assembly 105 or outer covering material on housing assembly 105. FIG. 3 is a side view of display 107b positioned on patch antenna 108. With reference to FIGS. 1A-1D, 2, and 3, in one or more embodiments, patch antenna 108 is a right hand circularly polarized antenna that includes: (i) ground plane 114 that is attachable to housing assembly 105 (FIG. 1D); (ii) substrate 115 of a low dielectric constant and low loss material (e.g., a plastic material in a range of 0.5 to 1 mm thickness) and positioned on ground plane 114; and (iii) conductive radiator patch 116 positioned on substrate 115. Conductive radiator patch 116 of patch antenna 108 has a first footprint size. Display 107b has a second footprint size that is smaller than the first footprint size of patch antenna 108. Display 107b is positioned on conductive radiator patch 116 of patch antenna 108 with second outer edge 201 (FIG. 2) of display 107b located within outer edge 203 (FIG. 2) of patch antenna 108. Second outer edge 201 (FIG. 2) of display 107b is spaced inwardly at least 1 mm from corresponding outer edge 203 (FIG. 2) of patch antenna 108, with exception of flex tail 118 of display 107b. In one or more embodiments, second antenna or coil 111 (FIG. 1A) may be similarly sized and positioned as an alternative to display 107b or be positioned between display 107b and patch antenna 108.

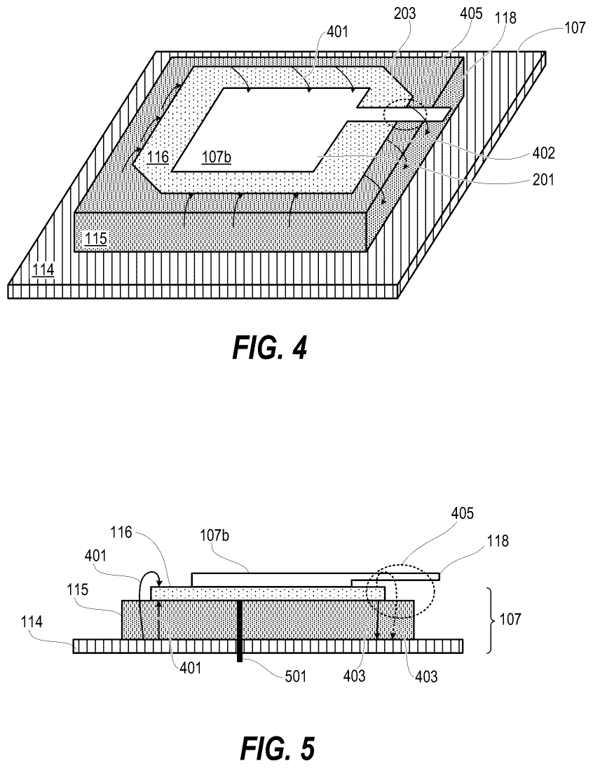

FIG. 4 is a three-dimensional view of display 107b positioned on patch antenna 108 and annotated with electromagnetic flux lines 401 from ground plane 114 to conductive radiator patch 116 and flux lines 402 from conductive radiator patch 116 to ground plane 114. Flux lines 401-402 are fringe fields at outer edge 203 of conductive radiator patch 116. Second outer edge 201 of display 107b may include conductors or other electromagnetically interfering component that are set back from outer edge 203, enabling coexistence within patch antenna 108 without significant interference with the fringe field. Only flex tail 118 with signal lines of display 107b passes through flux lines 401-402 of patch antenna 108. Relatively small area 405 of potential interference does not significantly degrade antenna performance of patch antenna 108. FIG. 5 is a side view of patch antenna 108 with functional component annotated with electromagnetic flux lines 401-402 and including probe line 501 that is a vertical feed that transfers signals to conductive radiator patch 116. In one or more embodiments, instead of probe line 501, patch antenna 108 may receive signals through a side feed transmission line on the same plane of conductive radiator patch 116 as depicted for display 107b and flex tail 118.

With continued reference to FIG. 1A, in addition to communications subsystem 102, communication device 101 may include controller 120, memory subsystem 122, data storage subsystem 124 and input/output (I/O) subsystem 126. To enable management by controller 120, system interlink 128 communicatively connects controller 120 with communications subsystem 102, memory subsystem 122, data storage subsystem 124 and input/output (I/O) subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1A, it is to be understood that more, fewer, or different interconnections may be present in other embodiments.

Controller 120 includes processor subsystem 130, which includes one or more central processing units (CPUs) or data processors. Processor subsystem 130 can include one or more digital signal processors that can be integrated with data processor(s). Processor subsystem 130 can include other processors such as auxiliary processor(s) that may act as a low power consumption, always-on sensor hub for physical sensors. Controller 120 manages, and in some instances directly controls, the various functions and/or operations of communication device 101. These functions and/or operations include, but are not limited to including, application data processing, communication with second communication devices, navigation tasks, image processing, and signal processing. In one or more alternate embodiments, communication device 101 may use hardware component equivalents for application data processing and signal processing. For example, communication device 101 may use special purpose hardware, dedicated processors, general purpose computers, microprocessor-based computers, micro-controllers, optical computers, analog computers, dedicated processors and/or dedicated hard-wired logic.

Memory subsystem 122 stores program code 132 for execution by processor subsystem 130 to provide the functionality described herein. Program code 132 includes applications such as communication application 134 that is configurable for communicating with satellite 109. Program code 132 may include other applications 136. These applications may be software or firmware that, when executed by controller 120, configures communication device 101 to provide functionality described herein. In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner. Implementation of program code 132 may use any known mechanism or process for doing so using integrated hardware and/or software, as known by those skilled in the art. Memory subsystem 122 further includes operating system (OS), firmware interface, such as basic input/output system (BIOS) or Uniform Extensible Firmware Interface (UEFI), and firmware, which also includes and may thus be considered as program code 132.

Program code 132 may access, use, generate, modify, store, or communicate computer data 140, such as antenna configuration data 142. Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 101 or be retrieved by communication device 101 from a second device, such as network server 146, to which communication device 101 can communicatively connect. Communication device 101 may store, modify, present, or transmit computer data 140. Computer data 140 may be organized in one of a number of different data structures. Common examples of computer data 140 include video, graphics, text, and images. Computer data 140 can also be in other forms of flat files, databases, and other data structures.

Data storage subsystem 122 of communication device 101 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory subsystem 122 for execution/processing by controller 120. In one or more embodiments, data storage device(s) 148 can include hard disk drives (HDDs), optical disk drives, and/or solid-state drives (SSDs), etc. Data storage subsystem 124 of communication device 101 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device, which stores program code/instructions that may be executed by a processor associated with a communication device such as communication device 101. Controller 120 can access data storage device(s) 148 or RSD 150 to provision communication device 101 with program code 132 and computer data 140.

I/O subsystem 126 may include input devices 154 such as microphone 156, image capturing devices 158, and touch input devices 160 (e.g., screens, keys or buttons). In one or more embodiments, input devices 154 includes a dedicated emergency alert control 161 that receives manual activation to trigger sending an emergency alert to satellite 109. Input devices 154 may receive a user input that indicates a trigger to initiate satellite communications. I/O subsystem 126 may include output devices 162 such as display 107, audio output devices 164, lights 166, and vibratory or haptic output devices 168. One or more of the output devices may present a status indication of an alert transmitted by communication device 101 to satellite 109. In an example, display content 112 is an alert status indication presented by display 107b.

In one or more embodiments, controller 120, via communications subsystem 102, performs multiple types of cellular over-the-air (OTA) or wireless communication, such as by using a Bluetooth connection or other personal access network (PAN) connection 170. In an example, user 172 may wear a health monitoring device depicted as smartwatch 174 that is communicatively coupled via connection 170. Smartwatch 174 may send a message to communication device that is a trigger for communicating with satellite 109. In an example, smartwatch 174 may detect a health abnormality of user 172, warranting immediate attention by healthcare first responder. In one or more embodiments, communications subsystem 102 includes global positioning system (GPS) module 176 that receives GPS broadcasts 178 from GPS satellites 180 to obtain geospatial location information. In one or more embodiments, controller 120, via communications subsystem 102, communicates via a wireless local area network (WLAN) link 182 using one or more IEEE 802.11 WLAN protocols with access point 184. In one or more embodiments, controller 120, via communications subsystem 102, may communicate via an OTA cellular connection 186 with radio access networks (RANs) 188. In an example, communication device 101, via communications subsystem 102, connects via RANs 188 of terrestrial network 190 that is communicatively connected to network server 146. According to aspects of the present disclosure, controller 120, via communications subsystem 102 and patch antenna 108, communicates via satellite link 192 with satellite 109 that is part of a non-terrestrial network 194.

Controller 120 may be directly communicatively coupled, or indirectly communicatively coupled via system interlink 128 or a support processor, to one or more physical sensors. In an example, physical sensors may include orientation sensor 195 configured to detect in which direction is up. Physical sensors may include pivot sensor 196 configured to detect at least one of a fully folded position, an intermediate pivoted position, and a fully unfolded position of first and second housings 104a-104b about hinge 106. Physical sensors may include motion sensor 197 configured to detect accelerations of housing assembly 105. Physical sensors (195, 196 and 197) may provide information used to detect a trigger to begin satellite communications. In an example, an abrupt deceleration may indicate a fall or a vehicular accident. In another example, a prolonged stationary period may indicate that communication device 101 was inadvertently dropped and not recovered. Physical sensors (195, 196 and 197) may provide information about whether housing assembly 105 is correctly oriented to present patch antenna 108 upward toward satellite 109. In an example, orientation sensor 195 may be positioned in one of first and second housings 104a-104b in which patch antenna 108 is positioned to directly detect orientation of patch antenna 108. In another example, orientation sensor 195 may be positioned in one of first and second housings 104a-104b in which patch antenna 108 is not positioned. By also detecting pivot position detected by pivot sensor 196, controller 120 can determine orientation of patch antenna 108. Alternatively, or in addition, communications subsystem 102 may provide information about whether patch antenna 108 is receiving a downlink or broadcast from satellite 109.

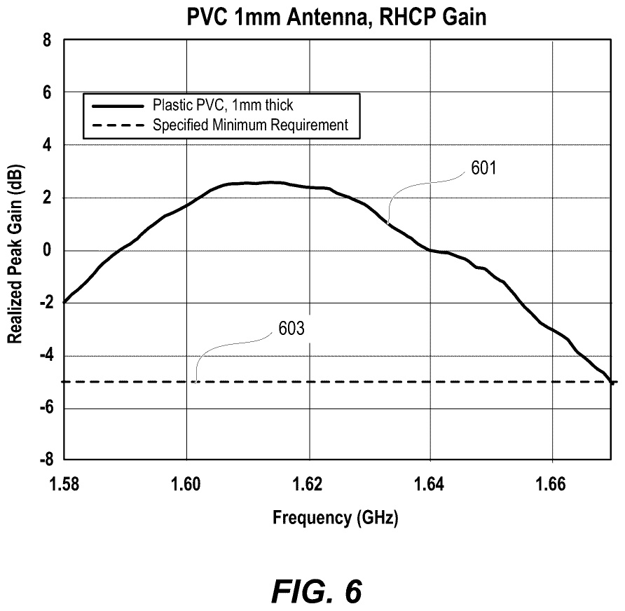

FIG. 6 is a graphical plot 601 of realized peak gain in decibels (dB) as a function of frequency of the patch antenna of FIG. 1. Horizontal plot 603 is an industry standard for realized peak gain. Satisfactory realized peak gain is above horizontal plot 603. In electromagnetics, an antenna's gain is a key performance parameter which combines the antenna's directivity and radiation efficiency. In a transmitting antenna, the gain describes how well the antenna converts input power into radio waves headed in a specified direction. In a receiving antenna, the gain describes how well the antenna converts radio waves arriving from a specified direction into electrical power. When no direction is specified, gain is understood to refer to the peak value of the gain, the gain in the direction of the antenna's main lobe. Gain or ‘absolute gain’ is defined as the ratio of the radiation intensity in a given direction to the radiation intensity that would be produced if the power accepted by the antenna were isotropically radiated. Due to reciprocity, the gain of any antenna when receiving is equal to its gain when transmitting. Realized gain differs from gain in that it is reduced by its impedance mismatch factor. This mismatch induces losses above the dissipative losses; therefore, realized gain will always be less than gain. A higher realized gain is better (i.e., more efficient) than a lower realized gain. Performance of the patch antenna 108 of FIG. 1A is better than an industry standard.

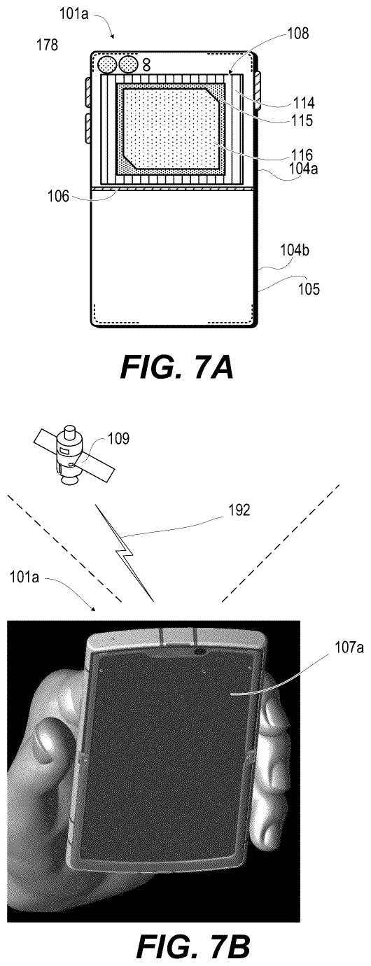

FIG. 7A is a back view of second example communication device 101a having a clamshell foldable design form that is unfolded with patch antenna 108 on a flip housing (first housing 104a) and no additional displays on back sides of housing assembly 105. FIG. 7B is a three-dimensional front view of second example communication device 101a of FIG. 7A being held in the unfolded position with main display 107a being viewable but tipped forward to orient patch antenna 108 (FIG. 7A) upward for satellite coverage.

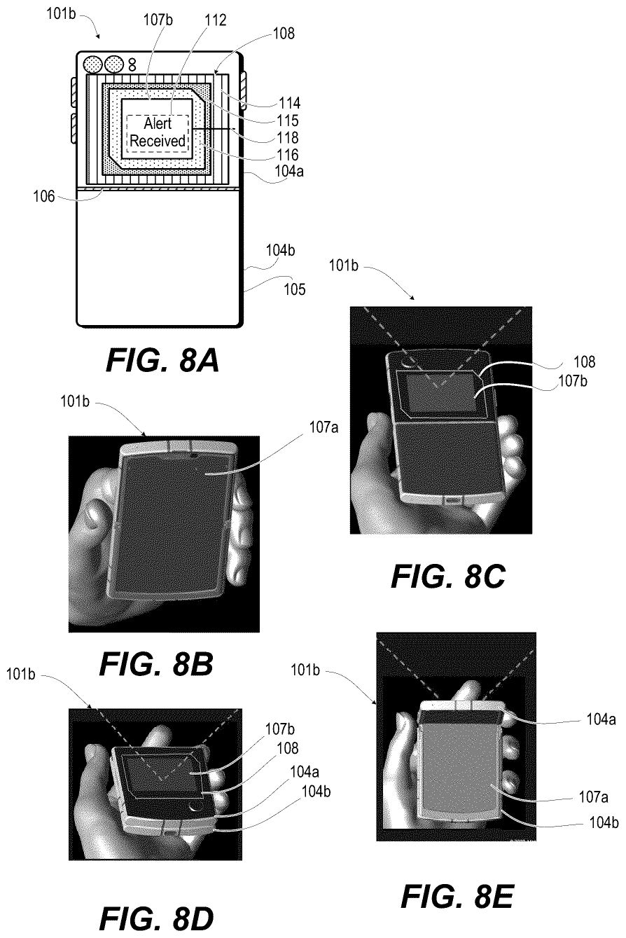

FIG. 8A is a back view of third example communication device 101b having a clamshell foldable design form that is unfolded with an additional display (e.g., display 107b) positioned on patch antenna 108 on the back side of the flip housing (i.e., first housing 104a). FIG. 8B is a three-dimensional front view of third example communication device 101b of FIG. 8A in a first use scenario. Third example communication device 101b is being held in the unfolded position with main display 107a being viewable but tipped forward to orient patch antenna 108 (FIG. 8A) upward for satellite coverage. FIG. 8C is a three-dimensional back view of third example communication device 101b of FIG. 8A in a second use scenario. Third example communication device 101b is being held in the unfolded position with the additional display (e.g., display 107b) being viewable on the base housing (i.e., second housing 104b) but tipped away from the user to orient patch antenna 108 upward for satellite coverage. FIG. 8D is a three-dimensional back view of third example communication device 101b of FIG. 8A in a third use scenario. Third example communication device 101b is being held in the folded position with the additional display (e.g., display 107b) being viewable upside down on the flip housing (i.e., first housing 104a) but tipped away from the user to orient patch antenna 108 upward for satellite coverage. Third example communication device 101b may detect the orientation of first housing 104a and automatically rotate display content to be viewed right side up. FIG. 8E is a three-dimensional back view of third example communication device 101b of FIG. 8A in a fourth use scenario. Base housing (i.e., second housing 104b) is being held vertically with a corresponding portion of main display 107a being viewable while the flip housing (i.e., first housing 104a) is horizontal in the tripod position of about 90° pivot position, orienting patch antenna 108 (FIG. 8A) upward for satellite coverage.

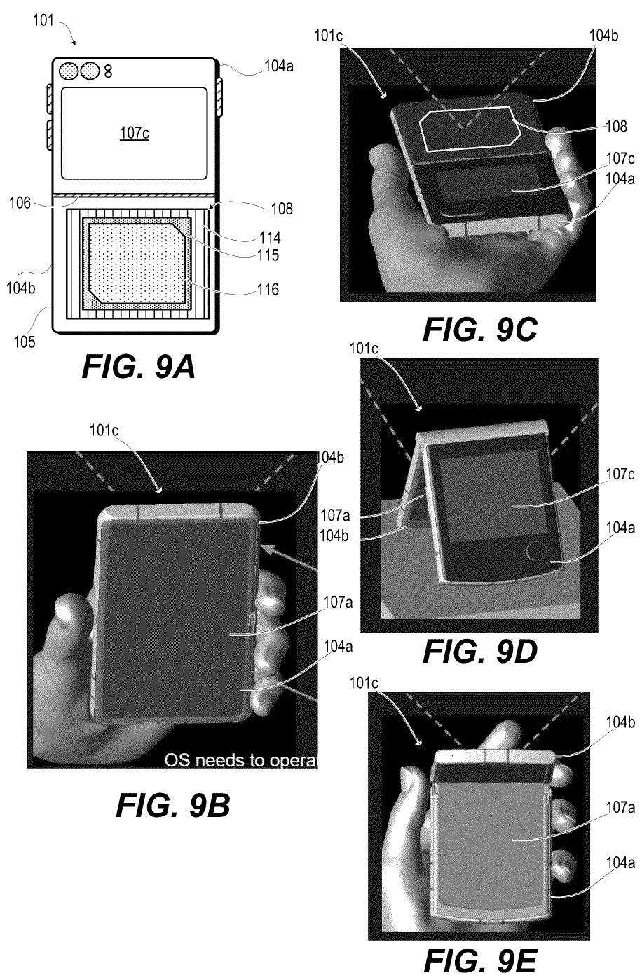

FIG. 9A is a back view of fourth example communication device 101c having a clamshell foldable design form that is unfolded. An additional display (e.g., unstacked back display 107c) is positioned on the back side of the flip housing (i.e., first housing 104a). Patch antenna 108 is positioned on the back side of the base housing (i.e., second housing 104b). FIG. 9B is a three-dimensional front view of fourth example communication device 101c of FIG. 9A in a first use scenario held upside down in the unfolded position. Main display 107a is viewable but tipped forward to orient patch antenna 108 upward for satellite coverage. FIG. 9C is a three-dimensional back view of fourth example communication device 101c of FIG. 9A in a second use scenario held upside down in the unfolded position. The additional display (e.g., unstacked back display 107c) is viewable but tipped away from the user to orient patch antenna 108 upward for satellite coverage. FIG. 9D is a three-dimensional view of fourth example communication device 101c of FIG. 9A in a third use scenario positioned with hinge 106 up in a partially unfolded book stand/tent position of less than 90° pivot position. The additional display (e.g., unstacked back display 107c) is viewable on one side and patch antenna 108 (FIG. 9A) is oriented generally upward for satellite coverage on an opposite side. FIG. 9E is a three-dimensional back view of fourth example communication device 101c of FIG. 9A in a fourth use scenario with the flip housing (i.e., first housing 104a) being held vertically upside down. A corresponding upside down portion of main display 107a is viewable while the flip housing (i.e., first housing 104a) is horizontal in the tripod position of about 90° pivot position orienting patch antenna 108 (FIG. 9A) upward for satellite coverage.

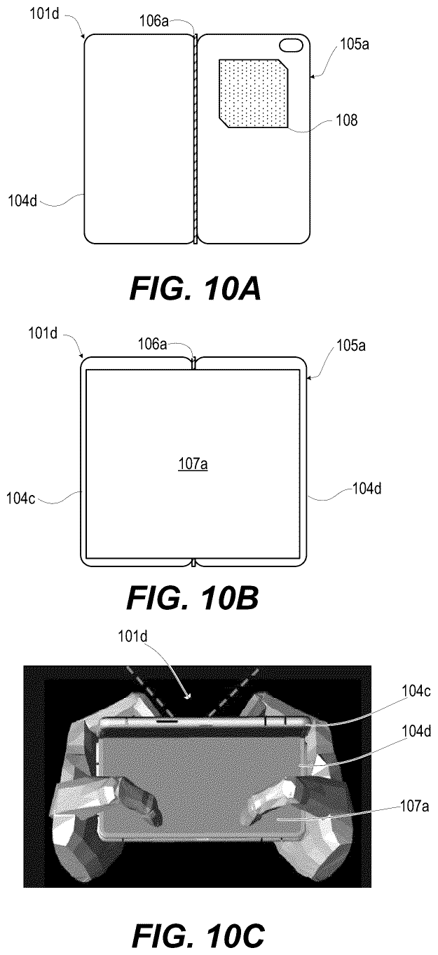

FIG. 10A is a back view of fifth example communication device 101d having a book-fold design form that is folded with no additional display. Patch antenna 108 is positioned on first housing 104c of housing assembly 105a. FIG. 10B is a front view of fifth example communication device 101d of FIG. 10A in an unfolded position to expose main display 107a across front sides of first housing 104c and second housing 104d of housing assembly 105a. FIG. 10C is a three-dimensional back view of fifth example communication device 101d of FIG. 10A in a use scenario with second housing 104d being held vertically and rotated a quarter turn left (i.e., downward). A corresponding portion of main display 107a is viewable. First housing 104c is horizontal in the tripod position of about 90° pivot position orienting patch antenna 108 (FIG. 10A) upward for satellite coverage.

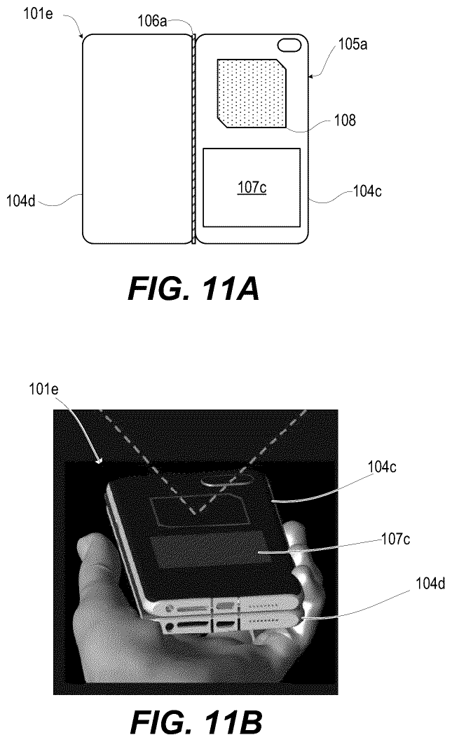

FIG. 11A is a back view of sixth example communication device 101e having a book-fold design form that is unfolded. Additional display (e.g., unstacked back display 107c) is positioned on the back side of first housing 104c beside patch antenna 108. As viewed, patch antenna 108 is above unstacked back display 107c. FIG. 11B is a three-dimensional back view of sixth example communication device 101e of FIG. 11A in a use scenario being held in the folded position. Additional display (e.g., unstacked back display 107c) is viewable on first housing 104c but is tipped away from the user to orient patch antenna 108 upward for satellite coverage.

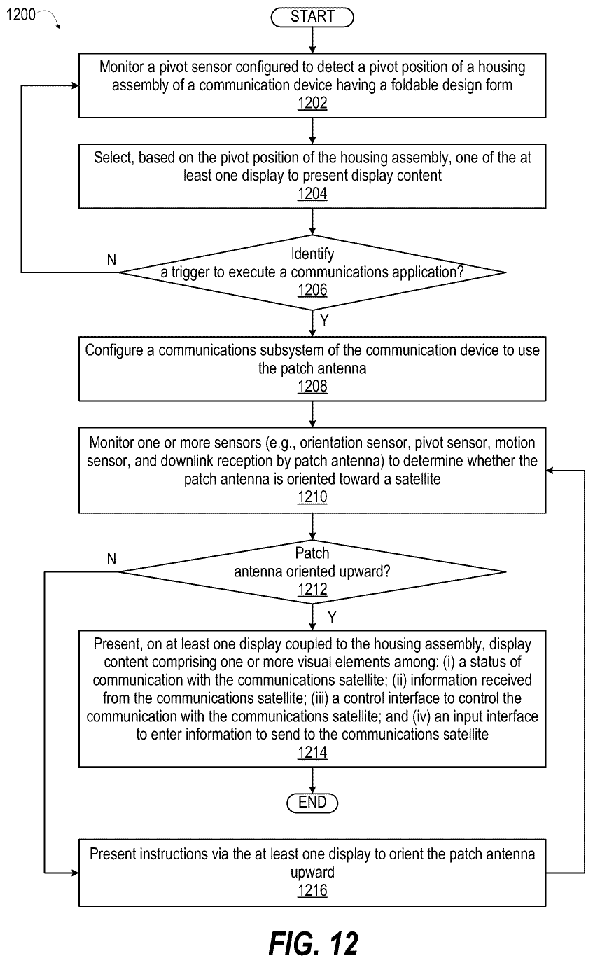

FIG. 12 is a flow diagram of a method of communicating with a satellite via a patch antenna incorporated into a communication device that has a foldable design form. The description of method 1200 is provided with general reference to the specific components illustrated within the preceding FIGS. 1A-1D, 2-5, 7A-7B, 8A-8E, 9A-9E, 10A-10C, and 11A-11B. Specific components referenced in method 1200 (FIG. 12) may be identical or similar to components of the same name used in describing preceding FIGS. 1A-1D, 2-5, 7A-7B, 8A-8E, 9A-9E, 10A-10C, and 11A-11B. In one or more embodiments, controller 120 (FIG. 1A) configures communication device 101 (FIG. 1A), communication device 101a (FIG. 7A), communication device 101b (FIG. 8A), communication device 101c (FIG. 9A), communication device 101d (FIG. 10A), communication device 101e (FIG. 11A), or a similar computing device to provide the described functionality of method 1200 (FIG. 12).

With reference to FIG. 12, method 1200 includes monitoring a pivot sensor configured to detect a pivot position of a housing assembly of a communication device having a foldable design form (block 1202). The housing assembly includes first and second housings coupled at a hinge to pivot between a fully folded position and a fully unfolded position. In one or more embodiments, the patch antenna is exposed in both the fully folded position and the fully unfolded position. The patch antenna includes: (i) a ground plane; (ii) a substrate comprising a low dielectric constant and low loss material and positioned on the ground plane; and (iii) a conductive radiator patch positioned on the substrate. Method 1200 includes selecting, based on the pivot position of the housing assembly, one of the at least one display to present display content (block 1204). In one or more embodiments, the at least one display includes a display positioned over the patch antenna. The display has a display footprint size that is smaller than a patch footprint size of the conductive radiator patch. A second outer edge of the display positioned within a corresponding outer edge of the conductive patch radiator to avoid interference with a fringe field of the patch antenna. The display is thus available with the patch antenna regardless of what other displays are available in a current pivot position of the communication device.

In one or more embodiments, a user is expected to manually orient the communication device such that the patch antenna is oriented generally upward toward one or more communication satellites. In one or more embodiments, the communication device includes more than one patch antenna positioned on opposing sides of the housing assembly to increase spatial diversity of antenna coverage. In one or more embodiments, the communication device provides instructions to reorient the communication device based on not receiving a downlink from a satellite via a communication subsystem of the communication device. In one or more embodiments, the communication device can detect the orientation of the patch antenna as provided by method 1200. With continued reference to FIG. 12, method 1200 includes identifying a trigger to execute a communications application (decision block 1206). In an example, an alert control button is activated. In another example, a health monitoring device such as a smartwatch that is communicatively coupled to communication device can provide a trigger such as an abnormal heart rhythm. In an additional example, a motion detector provides a trigger due to an acceleration that is detected indicative of a fall or vehicular accident. In a further example, the motion detector provides a trigger due to a lack of acceleration for a period of time that may be indicative of a misplaced communication device or an incapacitated user. In response to not identifying a trigger to execute a communications application by a communication device to communicate with a communications satellite in decision block 1206, method 1200 returns to block 1202. In response to identifying a trigger to execute a communications application by a communication device to communicate with a communications satellite, method 1200 includes configuring a communications subsystem of the communication device to use a patch antenna positioned on a back portion of the housing assembly (block 1208). Method 1200 includes monitoring one or more sensors (e.g., orientation sensor, pivot sensor, motion sensor, and downlink reception by patch antenna) to determine whether the patch antenna is oriented toward a satellite (e.g., upwards) (block 1210). Method 1200 includes determining whether the patch antenna is oriented upward based on the one or more sensors (decision block 1212). In one or more embodiments, the hinge of the device housing is configured to maintain an intermediate pivot position for orienting the communication device in a book stand position at a right angle or a tent position at an acute angle. Method 1200 further include determining the orientation of the patch antenna based on one of: (i) monitoring the orientation sensor positioned to move with the patch antenna; or (ii) monitoring the orientation sensor positioned to pivot about the hinge relative to the patch antenna and monitoring the pivot sensor to determine the intermediate position. In response to determining that the patch antenna is oriented upward based on the one or more sensors in decision block 1212, method 1200 includes presenting, on at least one display (e.g., display) coupled to the housing assembly, display content that includes one or more visual elements among: (i) a status of communication with the communications satellite; (ii) information received from the communications satellite; (iii) a control interface to control the communication with the communications satellite; and (iv) an input interface to enter information to send to the communications satellite (block 1214). Then method 1200 ends. In response to determining that the patch antenna is not oriented upward based on the one or more sensors in decision block 1212, method 1200 includes presenting instructions via the at least one display (e.g., display) to orient the patch antenna upward (block 1216). Then method 1200 returns to block 1210.

In one or more embodiments, method 1200 may further include monitoring one or more sensors configured to detect an orientation of the patch antenna. Method 1200 includes communicating, via the communications subsystem and the patch antenna with the communications satellite, in response to detecting the patch antenna is oriented upward. Method 1200 may further include presenting instructions via the at least one display to orient the patch antenna upward, in response to detecting the patch antenna is not oriented in the right direction (e.g., oriented downward or sideways) prior to initiating communication via the patch antenna. Method 1200 may further include communicating, via the communications subsystem and the patch antenna with the communications satellite, in response to subsequently detecting the patch antenna is re-oriented upward.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”. “an” and “the” are intended to include the plural forms as well, unless the context clearly indicates otherwise. It will be further understood that the terms “comprise” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A communication device comprising:
a housing assembly comprising first and second housings coupled at a hinge to pivot between a fully folded position and a fully unfolded position; and
a patch antenna positioned at a back portion of the housing assembly that is exposed in both the fully folded position and the fully unfolded position, the patch antenna comprising: (i) a ground plane; (ii) a substrate comprising a low dielectric constant and low loss material and positioned on the ground plane; and (iii) a conductive radiator patch positioned on the substrate.

2. The communication device of claim 1, further comprising:
a communications subsystem configured to allow the communication device to communicate with a communications satellite via at least one of an uplink and a downlink;
a memory that stores a communications application; and
a controller communicatively coupled to the communications subsystem and the memory, and which:
in response to identifying a trigger to execute the communications application, communicates, via the communications subsystem and the patch antenna with the communications satellite.

3. The communication device of claim 2, further comprising at least one display coupled to the housing assembly and communicatively coupled to the controller, and wherein the controller presents, on the at least one display, display content comprising one or more visual elements among: (i) a status of communication with the communications satellite; (ii) information received from the communications satellite; (iii) a control interface to control the communication with the communications satellite; and (iv) an input interface to enter information to send to the communications satellite.

4. The communication device of claim 3, wherein:
the communications application comprises an emergency alert application; and
the controller presents a communications user interface, at the at least one display, indicating a status of sending an emergency alert based on communication with the communications satellite.

5. The communication device of claim 3, wherein the at least one display comprises a display positioned over the patch antenna, the display having a display footprint size that is smaller than a patch footprint size of the conductive radiator patch, a second outer edge of the display positioned within a corresponding outer edge of the conductive patch radiator.

6. The communication device of claim 3, further comprising a pivot sensor communicatively coupled to the controller and configured to detect a pivot position of the housing assembly, and wherein the controller:
monitors the pivot sensor; and
selects, based on the pivot position of the housing assembly, one of the at least one display to present display content.

7. The communication device of claim 2, further comprising one or more sensors communicatively coupled to the controller and configured to detect an orientation of the patch antenna, and wherein the controller:
monitors the one or more sensors to detect whether the patch antenna is oriented upward; and
communicates, via the communications subsystem and the patch antenna with the communications satellite, in response to detecting the patch antenna is oriented upward.

8. The communication device of claim 7, further comprising at least one display communicatively coupled to the controller, and wherein the controller:
presents instructions via the at least one display to orient the patch antenna upward, in response to detecting the patch antenna is oriented downward prior to initiating communication via the patch antenna; and
communicates, via the communications subsystem and the patch antenna with the communications satellite, in response to subsequently detecting the patch antenna is re-oriented upward.

9. The communication device of claim 7, wherein:
the hinge of the device housing is configured to maintain an intermediate pivot position for orienting the communication device in a book stand position at a right angle or a tent position at an acute angle; and
the controller determines the orientation of the patch antenna based on one of: (i) directly monitoring the orientation of the patch antenna based on the one or more sensors positioned to move with the patch antenna; or (ii) indirectly monitoring the orientation of the patch antenna based on detecting a pivot position of the housing assembly and detecting an orientation of another one of the first and second housing of the housing assembly that does not comprise the patch antenna.

10. The communication device of claim 1, wherein:
the patch antenna is configured to transmit and to receive a right hand circularly polarized (RHCP) radio frequency (RF) signal; and
the substrate comprises a plastic material of 1 mm thickness.

11. A method comprising:
in response to identifying a trigger to execute a communications application by a communication device to communicate with a communications satellite:
configuring a communications subsystem of the communication device to use a patch antenna positioned on a back portion of a housing assembly comprising first and second housings coupled at a hinge to pivot between a fully folded position and a fully unfolded position, the patch antenna exposed in both the fully folded position and the fully unfolded position and comprising: (i) a ground plane; (ii) a substrate comprising a low dielectric constant and low loss material and positioned on the ground plane; and (iii) a conductive radiator patch positioned on the substrate; and
communicating, via the patch antenna with the communications satellite.

12. The method of claim 11, presenting, on at least one display coupled to the housing assembly, display content comprising one or more visual elements among: (i) a status of communication with the communications satellite; (ii) information received from the communications satellite; (iii) a control interface to control the communication with the communications satellite; and (iv) an input interface to enter information to send to the communications satellite.

13. The method of claim 12, further comprising presenting a communications user interface for the communications application on the at least one display comprising a display positioned over the patch antenna, the display having a display footprint size that is smaller than a patch footprint size of the conductive radiator patch, a second outer edge of the display positioned within a corresponding outer edge of the conductive patch radiator.

14. The method of claim 12, further comprising:
monitoring a pivot sensor configured to detect a pivot position of the housing assembly; and
selecting, based on the pivot position of the housing assembly, one of the at least one display to present display content.

15. The method of claim 12, further comprising:
monitoring one or more sensors configured to detect an orientation of the patch antenna; and
communicating, via the communications subsystem and the patch antenna with the communications satellite, in response to detecting the patch antenna is oriented upward.

16. The method of claim 15, further comprising:
presenting instructions via the at least one display to orient the patch antenna upward, in response to detecting the patch antenna is oriented downward prior to initiating communication via the patch antenna; and
communicating, via the communications subsystem and the patch antenna with the communications satellite, in response to subsequently detecting the patch antenna is re-oriented upward.

17. The method of claim 15, wherein:
the hinge of the device housing is configured to maintain an intermediate pivot position for orienting the communication device in a book stand position at a right angle or a tent position at an acute angle; and
the one or more sensors comprise an orientation sensor configured to detect an orientation of a portion of the housing assembly and a pivot sensor configured to detect a pivot position of the housing assembly, and the method further comprising determining the orientation of the patch antenna based on one of: (i) monitoring the orientation sensor positioned to move with the patch antenna; or (ii) monitoring the orientation sensor positioned to pivot about the hinge relative to the patch antenna and monitoring the pivot sensor to determine the intermediate position.

18. A computer program product comprising:
a computer readable storage device; and
program code on the computer readable storage device that when executed by a processor associated with a communication device, the program code enables the communication device to provide functionality of:
in response to identifying a trigger to execute a communications application by a communication device to communicate with a communications satellite:
configuring a communications subsystem of the communication device to use a patch antenna positioned on a back portion of a housing assembly comprising first and second housings coupled at a hinge to pivot between a fully folded position and a fully unfolded position, the patch antenna exposed in both the fully folded position and the fully unfolded position and comprising: (i) a ground plane; (ii) a substrate comprising a low dielectric constant and low loss material and positioned on the ground plane; and (iii) a conductive radiator patch positioned on the substrate; and
communicating, via the patch antenna with the communications satellite.

19. The computer program product of claim 18, wherein the program code enables the communication device to provide functionality of presenting, on at least one display, a communications user interface for the communications application comprising an emergency alert application based on communication with the communications satellite.

20. The computer program product of claim 18, wherein the program code enables the communication device to provide functionality of presenting, on at least one display coupled to the housing assembly, display content comprising one or more visual elements among: (i) a status of communication with the communications satellite; (ii) information received from the communications satellite; (iii) a control interface to control the communication with the communications satellite; and (iv) an input interface to enter information to send to the communications satellite.
